(19) United States
(12) Patent Application Publication
(10) Pub. No.: US 2026/0333395 A1
(43) Pub. Date: Oct. 22, 2026

(54) METHOD AND APPARATUS FOR SIDELINK COMMUNICATION IN A WIRELESS COMMUNICATION SYSTEM

(71) Applicant: Samsung Electronics Co., Ltd., Gyeonggi-do (KR)

(72) Inventors: Miao ZHOU, Beijing (CN); Feifei SUN, Beijing (CN); Min WU, Beijing (CN)

(21) Appl. No.: 19/116,787

(22) PCT Filed: Aug. 4, 2023
(86) PCT No.: PCT/KR2023/011535

§ 371 Date: Mar. 28, 2025

(30) Foreign Application Priority Data
Sep. 28, 2022 (CN) 202211194249.1
Nov. 4, 2022 (CN) 202211380078.1

(51) Int. Cl. H04W 72/25; H04L 5/00; H04W 74/08

(52) U.S. Cl. CPC H04W 72/25; H04L 5/0055; H04W 74/0866

(57) ABSTRACT

A method and device for sidelink communication are disclosed, the method including: if a sidelink signal and/or channel is transmitted, performing a contention window adjustment procedure forming a contention window adjustment procedure based on at least one information of: a cast type, mation of: a cast type, a hybrid automatic repeat request-acknowledge (HARQ-ACK) option, whether HARQ-ACK feedback is enabled for the sidelink signal and/or channel, a HARQ-ACK status corresponding to the sidelink signal and/or channel, and a sidelink measurement result; performing a channel access procedure based on the contention window.

### TECHNICAL FIELD

The invention relates to the technical field of wireless communication, and more specifically, to a method and a device for sidelink communication.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre- 5G communication systems. Therefore, 5G or pre- 5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid FSK and QAM modulation (FQAM) and sliding window superlocation coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

The present invention provides a transmission method after the signal of the sidelink communication is introduced into the positioning reference signal for SL, so that the transmission control based on channel busy ratio (CBR) measurement in the sidelink communication can also be used for the positioning reference signal for SL.

### BRIEF DESCRIPTION OF DRAWINGS

In order to illustrate the technical schemes of the embodiments of the present disclosure more clearly, the drawings of the embodiments of the present disclosure will be briefly introduced below. Apparently, the drawings described below only refer to some embodiments of the present disclosure, and do not limit the disclosure. In the drawings:

FIG. 1 illustrates a schematic diagram of an example wireless network according to some embodiments of the present disclosure;

FIGS. 2A and 2B illustrate example wireless transmission and reception paths according to some embodiments of the present disclosure;

FIG. 3A illustrates an example user equipment (UE) according to some embodiments of the present disclosure;

FIG. 3B illustrates an example gNB according to some embodiments of the present disclosure;

FIG. 4 illustrates a flowchart of a method according to various embodiments of the present disclosure;

FIG. 5 illustrates another flowchart of a method according to various embodiments of the present disclosure;

FIG. 6 illustrates another flowchart of a method according to various embodiments of the present disclosure;

FIG. 7 illustrates another flowchart of a method according to various embodiments of the present disclosure;

FIG. 8 illustrates a block diagram of a configuration of a UE according to various embodiments of the present disclosure; and

FIG. 9 illustrates a block diagram illustrating a structure of a UE according to an embodiment of the disclosure; and

FIG. 10 illustrates a block diagram illustrating a structure of a BS according to an embodiment of the disclosure.

### BEST MODE FOR CARRYING OUT THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Some embodiments of the present invention provide a method performed by user equipment (UE), including: if a sidelink signal and/or channel is transmitted, performing a contention window adjustment procedure based on at least one information of: a cast type, a hybrid automatic repeat request-acknowledge (HARQ-ACK) option, whether HARQ-ACK feedback is enabled for the sidelink signal and/or channel, a HARQ-ACK status corresponding to the sidelink signal and/or channel, and a sidelink measurement result; performing a channel access procedure based on the contention window.

In some implementations, the at least one information further includes at least one of: a priority of the sidelink signal and/or channel; a HARQ-ACK status transmitted by the UE to other UEs; whether HARQ-ACK feedback is enabled for a transmission of other UEs.

In some implementations, the performing of the contention window adjustment procedure includes: determining the HARQ-ACK status corresponding to the sidelink signal and/or channel based on at least one of the cast type, the HARQ-ACK option, whether HARQ-ACK feedback is enabled for the sidelink signal and/or channel, and a status indicated by a received HARQ-ACK feedback corresponding to the sidelink signal and/or channel; performing the contention window adjustment procedure based on the HARQ-ACK status corresponding to the sidelink signal and/or channel.

In some implementations, the determining of the HARQ-ACK status corresponding to the sidelink signal and/or channel includes at least one of: if the cast type is broadcast, and/or if HARQ-ACK feedback is disabled for transmission of the sidelink signal and/or channel, setting a HARQ-ACK status of the transmission to ACK, or to NACK, or not using the transmission in the contention window adjustment procedure,
if the cast type is groupcast, and/or if a groupcast HARQ-ACK option with NACK-only feedback is enabled for the transmission of the sidelink signal and/or the channel, when NACK corresponding to the transmission is received, setting the HARQ-ACK status of the transmission to NACK, otherwise, setting the HARQ-ACK status of the transmission to ACK,
if the cast type is groupcast, and/or if a groupcast HARQ-ACK option with both ACK and NACK feedback is enabled for the transmission of the sidelink signal and/or channel, for at least one transmission and/or retransmission of the sidelink signal and/ or channel, when at least one ACK corresponding to the transmission is received or when a number of received ACKs corresponding to the transmission exceeds a given threshold, setting the HARQ-ACK status of the transmission to ACK, otherwise, setting the HARQ-ACK status of the transmission to NACK,
if the cast type is groupcast, and/or if the groupcast HARQ-ACK option with both ACK and NACK feedback is enabled for the transmission of the sidelink signal and/or channel, for any transmission and/or retransmission of the sidelink signal and/or channel, when at least one ACK corresponding to the transmission is received or when the number of the received ACKs corresponding to the transmission exceeds the given threshold, setting the HARQ-ACK status of the transmission to ACK, otherwise, setting the HARQ-ACK status of the transmission to NACK,
if the cast type is groupcast, and/or if the groupcast HARQ-ACK option with both ACK and NACK feedback is enabled for the transmission of the sidelink signal and/or channel, for at least one transmission and/or retransmission of the sidelink signal and/ or channel, when all ACKs corresponding to the transmission are received, setting the HARQ-ACK status of the transmission to ACK, otherwise, setting the HARQ-ACK status of the transmission to NACK, and
if the cast type is groupcast, and/or if the groupcast HARQ-ACK option with both ACK and NACK feedback is enabled for the transmission of the sidelink signal and/or channel, for any transmission and/or retransmission of the sidelink signal and/or channel, when all ACKs corresponding to the transmission are received, setting the HARQ-ACK status of the transmission to ACK, otherwise, setting the HARQ-ACK status of the transmission to NACK.

In some implementations, the performing of the contention window adjustment procedure includes performing at least one of: adjusting an initial value of a contention window parameter CWP; adjusting an amplitude by which the contention window parameter CWP is adjusted; adjusting a number of times for which the contention window parameter CWP is consecutively maintained at a maximum value; determining to adjust a contention window corresponding to a specific channel access priority class (CAPC).

In some implementations, further including: acquiring configuration information including at least two values of information related to a contention window parameter CWP; determining a value from the at least two values based on the at least one information.

In some implementations, the information related to the contention window parameter CWP includes at least one of: a minimum value of the contention window parameter CWP; a maximum value of the contention window parameter CWP; a set of values of the contention window parameter CWP; an initial value of the contention window parameter CWP; an amplitude by which the contention window parameter CWP is adjusted; a number of times for which the contention window parameter CWP is consecutively maintained at the maximum value; a contention window corresponding to at least one channel access priority class (CAPC).

In some implementations, the performing of the contention window adjustment procedure based on the HARQ-ACK status corresponding to the sidelink signal and/or channel includes: performing the contention window adjustment procedure according to a ratio and/or number of specific HARQ-ACK statuses and/or a number of times of consecutive specific HARQ-ACK statuses in a specific time range.

In some implementations, the performing of the contention window adjustment procedure based on the HARQ-ACK status transmitted by the UE to other UEs and/or whether HARQ-ACK feedback is enabled for the transmission of other UEs includes: not using a HARQ-ACK status that does not need to be transmitted in the contention window adjustment procedure, and/or performing the contention window adjustment procedure based on information on whether the transmission from other UEs is successfully received.

In some implementations, the performing of the contention window adjustment procedure based on the sidelink measurement result includes: determining whether or how to adjust the contention window based on a comparison result between the sidelink measurement result and a threshold.

In some implementations, the performing of the contention window adjustment procedure includes at least one of: determining a CAPC of the sidelink signal and/or channel based on the at least one information corresponding to the sidelink signal and/ or channel, and determining or adjusting a contention window corresponding to the CAPC; determining the CAPC of the sidelink signal and/or channel based on the at least one information, and determining or adjusting the contention window based on the determined CAPC and/or based on the at least one information corresponding to the sidelink signal and/or channel.

Some embodiments of the present invention provide a method performed by a first user equipment (UE), including: receiving signaling from a second UE, wherein the signaling includes related information on channel occupancy (CO) shared by the second UE to the first UE; and transmitting at least one channel of a physical sidelink feedback channel (PSFCH), a physical sidelink control channel (PSCCH) and a physical sidelink shared channel (PSSCH) on the CO based on the related information; or transmitting at least one channel of a groupcasted and/or broadcasted PSCCH and/or PSSCH on the CO; wherein the related information includes at least one of: indicating a type of a signal and/or a channel that can be transmitted by the second UE on the CO; indicating whether the second UE can transmit to other UEs on the CO; indicating whether the second UE can transmit a specific cast type on the CO; indicating a method for the second UE to transmit groupcast and/or broadcast on the CO; indicating that the CO is a CO initialized by the second UE; indicating that the CO is a CO shared to the second UE; information indicating whether the first UE receiving the signaling can transmit a HARQ-ACK on the CO; and information indicating whether a third UE receiving the at least one channel from the first UE can transmit a HARQ-ACK on the CO.

In some implementations, the transmitting of the at least one channel of the groupcasted and/or broadcasted PSCCH and/or PSSCH on the CO includes at least one of:
if HARQ-ACK feedback is disabled for the transmission or a cast type of the transmission is broadcast, transmitting the groupcasted and/or broadcasted PSCCH and/or PSSCH on the CO, otherwise, not transmitting the groupcasted and/or broadcasted PSCCH and/or PSSCH on the CO,
if a specific HARQ-ACK feedback type is enabled for the transmission, transmitting the groupcasted and/or broadcasted PSCCH and/or PSSCH on the CO, otherwise, not transmitting the groupcasted and/or broadcasted PSCCH and/or PSSCH on the CO, and
if the at least one channel is transmitted on the CO and HARQ-ACK feedback is enabled for the transmission, expecting to receive HARQ-ACK feedback transmitted on the CO from the second UE, and not expecting to receive HARQ-ACK feedback transmitted on the CO from other UEs.

In some implementations, further including: if a groupcast HARQ-ACK feedback type with NACK-only feedback is enabled for the transmission, if an NACK from the second UE is received, a HARQ-ACK status corresponding to the transmission is NACK, otherwise, the HARQ-ACK status corresponding to the transmission is ACK;
if a groupcast HARQ-ACK feedback type with both ACK and NACK feedback is enabled for the transmission, if an ACK from the second UE is received, the HARQ-ACK status corresponding to the transmission is ACK, otherwise, the HARQ-ACK status corresponding to the transmission is NACK.

Some embodiments of the present invention provide a method performed by a second user equipment (UE), including: initializing channel occupancy (CO); and transmitting signaling to a first UE, wherein the signaling includes related information on the channel occupancy (CO) shared by the second UE to the first UE, wherein the related information includes at least one of: indicating a type of a signal and/or a channel that can be transmitted by the second UE on the CO; indicating whether the second UE can transmit to other UEs on the CO; indicating whether the second UE can transmit a specific cast type on the CO; indicating a method for the second UE to transmit groupcast and/or broadcast on the CO; indicating that the CO is a CO initialized by the second UE; indicating that the CO is a CO shared to the second UE; information indicating whether the UE receiving the signaling can transmit a HARQ-ACK on the CO; information indicating whether a third UE receiving at least one channel of a physical sidelink feedback channel (PSFCH), a physical sidelink control channel (PSCCH) and a physical sidelink shared channel (PSSCH) from the first UE can transmit a HARQ-ACK on the CO; and information indicating whether the third UE receiving at least one channel of a groupcasted and/or broadcasted PSCCH and/or PSSCH from the first UE can transmit a HARQ-ACK on the CO.

Some embodiments of the present invention provide a method performed by a user equipment (UE), including: acquiring a configuration of a positioning reference signal for sidelink (SL); and based on the configuration of the positioning reference signal for SL, performing at least one of: measuring a channel busy ratio (CBR), determining a channel occupancy ratio (CR), and dropping transmission based on a CR upper limit.

In some implementations, the measuring of the CBR includes measuring at least one of:
a first CBR corresponding to a ratio of subchannels in a resource pool on which a reference signal received power (RSRP) and/or received signal strength indicator (RSSI) of the positioning reference signal for SL exceeds a configured threshold in a CBR measurement window,
a second CBR corresponding to a ratio of subchannels in the resource pool on which the RSSI exceeds the configured threshold in the CBR measurement window,
a third CBR corresponding to a ratio of subchannels in a first resource set on which the RSRP and/or RSSI of the positioning reference signal for SL exceeds the configured threshold in the CBR measurement window,
a fourth CBR corresponding to a ratio of subchannels in a second resource set on which an RSRP and/or RSSI of a physical sidelink control channel (PSCCH) and/or physical sidelink shared channel (PSSCH) exceeds the configured threshold in the CBR measurement window, and
a fifth CBR corresponding to a value calculated based on at least one of the second CBR, the third CBR and the fourth CBR.

In some implementations, the CBR measurement window is determined based on a positioning reference signal measurement window for positioning.

In some implementations, if the measured CBR includes more than one CBR of the first CBR, the second CBR, the third CBR, the fourth CBR and the fifth CBR, the measured CBR is determined as at least one of: a maximum value of the more than one CBR, a minimum value of the more than one CBR, and a CBR obtained based on the more than one CBR.

In some implementations, the dropping of the transmission based on the CR upper limit includes at least one of:
enabling CR corresponding to all transmissions of the positioning reference signal for SL, a physical sidelink control channel (PSCCH) and a physical sidelink shared channel (PSSCH) not to exceed the CR upper limit by dropping transmission of at least one of the positioning reference signal for SL, the PSCCH and the PSSCH, enabling first CR corresponding to transmission of the positioning reference signal for SL not to exceed a first CR upper limit by dropping the transmission of the positioning reference signal for SL, if the first CR upper limit corresponds to a CBR measured based on the positioning reference signal for SL, and
enabling a second CR corresponding to the transmission of the positioning reference signal for SL not to exceed a second CR upper limit by dropping transmission of the PSCCH and/or the PSSCH, if the second CR upper limit corresponds to a CBR measured based on the PSCCH and/or the PSSCH.

In some implementations, the dropping of the transmission based on the CR upper limit includes dropping the transmission based on a priority, which includes at least one of:
preferentially dropping transmission with a lower priority to meet the CR upper limit based on a priority of transmission of at least one of the positioning reference signal for SL, a physical sidelink control channel (PSCCH) and a physical sidelink shared channel (PSSCH), and
determining to preferentially drop transmission of the positioning reference signal for SL, and/or preferentially drop transmission of the PSCCH and/or the PSSCH based on a predetermined and/or configured criterion.

Some embodiments of the present disclosure also provide a user equipment (UE), including: a transceiver configured to transmit and receive signals; and a controller coupled with the transceiver and configured to perform the aforementioned methods.

The present invention provides a method for adjusting the contention window based on the HARQ-ACK feedback information, which can enable the UE to determine the channel state more accurately based on HARQ-ACK, and adjust the length of the contention window on this basis to occupy the channel more reliably.

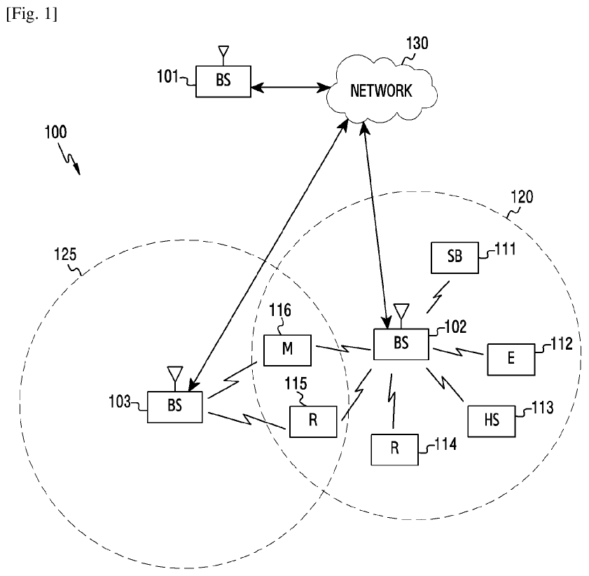

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

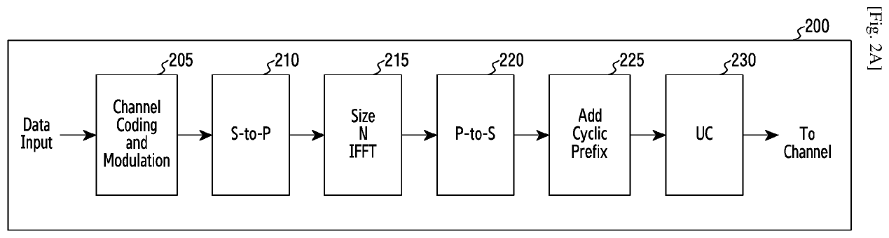

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116.

However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

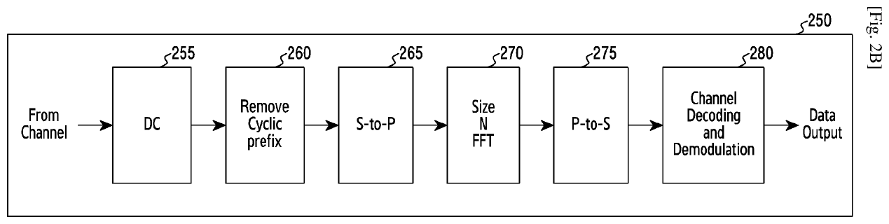

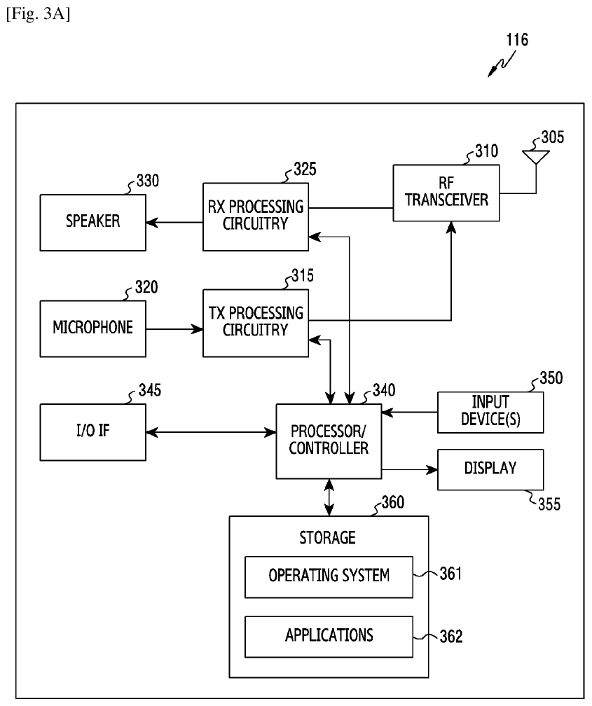

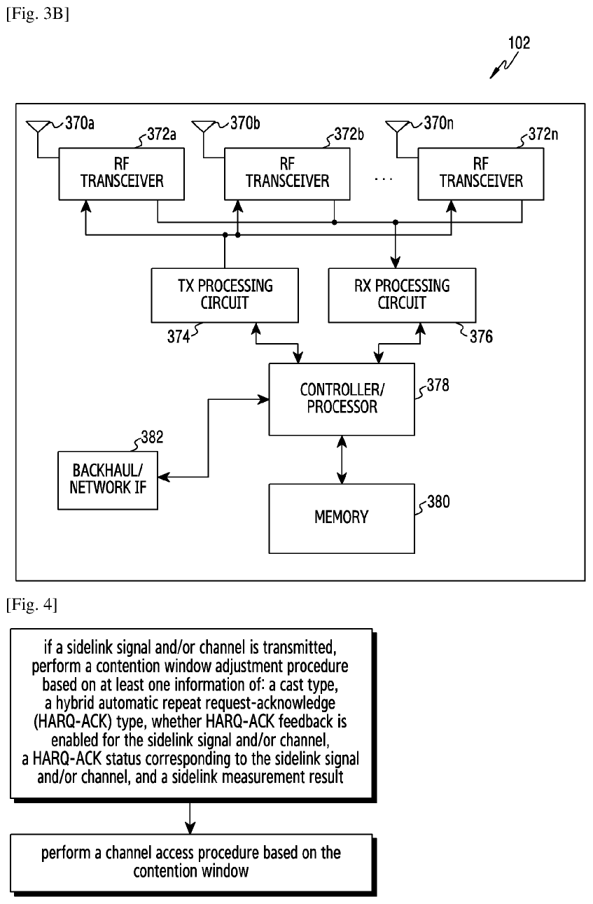

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/ controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/ controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/ controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370 a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/ processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In the Long Term Evolution (LTE) technology, sidelink communication includes two main types of mechanisms including direct Device to Device (D2D) communication and Vehicle to Outside communication (Vehicle to Vehicle/Infrastructure/Pedestrian/Network, collectively referred to as V2X), where the V2X communication is designed based on the D2D technology, is superior to the D2D in data rate, delay, reliability and link capacity, and is the most representative sidelink communication technology in LTE technology. In 5G systems, at present, sidelink communication mainly includes Vehicle to Outside (V2X) communication.

As the evolution technology of LTE, 5G NR systems also include the further evolution of sidelink communication accordingly. NR V2X technology was formulated in Release 16. As the evolution version of LTE V2X technology, NR V2X has superior performance in all aspects. In Release 17, 5G NR systems are expected to further expand the application scenarios of NR V2X to other broader application scenarios, e.g., commercial sidelink communication and Public Safety (PS) scenarios. In Release 18, the evolution of sidelink communication includes the direction of unlicensed frequency band, FR2, carrier aggregation, co-channel coexistence with LTE, etc., and also includes the support for technologies in other fields such as positioning.

In embodiments of the present application, information configured by a base station, information indicated by signaling, information configured by a higher layer, and pre-configured information include: a set of configuration information; multiple sets of configuration information, where the UE selects a set of configuration information therefrom for use according to a predefined condition; a set of configuration information including multiple subsets, where the UE selects a subset therefrom for use according to a predefined condition.

In embodiments of the present application, “lower than a threshold” may also be replaced by “lower than or equal to a threshold”, “higher than a threshold” may also be replaced by “higher than or equal to a threshold”, “less than or equal to” may also be replaced by “less than”, and “larger than or equal to” may also be replaced by “larger than”, and vice versa.

In embodiments of the present application, a part of the technical schemes provided are specifically described based on the V2X system, but their application scenarios should not be limited to the V2X system in sidelink communication, but may also be applied to other sidelink transmission systems. For example, the design based on V2X sub-channels in the following embodiments may also be used for D2D sub-channels or other sub-channels for sidelink transmission. The V2X resource pool in the following embodiments may also be replaced by the D2D resource pool in other sidelink transmission systems such as the D2D.

In embodiments of the present application, when a sidelink communication system is the V2X system, a terminal or UE may be various types of terminals or UEs such as Vehicle, Infrastructure, and Pedestrian, etc.

A base station in the present specification may also be replaced by other nodes, such as sidelink nodes, and a specific example is an infrastructure UE in the sidelink system. Any mechanism applicable to the base station in the specification may also be similarly used in the scenario where the base station is replaced by other sidelink nodes, and the illustration will not be repeated.

A slot in the present specification may also be replaced by a time unit, a candidate slot may also be replaced by a candidate time unit, and a candidate slot resource may also be replaced by a candidate time unit resource. The time unit includes a specific time length, such as several consecutive symbols.

A slot in the present specification may be either a subframe or slot in a physical sense, or a subframe or slot in a logical sense. Specifically, the subframe or slot in the logical sense is a subframe or slot corresponding to a resource pool for sidelink communication. For example, in the V2X system, the resource pool is defined by a repeated bitmap mapped to a specific slot set, which may be all slots or all other slots except some specific slots (such as slots for transmitting an MIB (Master Information Block)/SIB (System Information Block)). A slot indicated as “1” in the bitmap may be used for V2X transmission and belongs to slots corresponding to the V2X resource pool. A slot indicated as “0” cannot be used for V2X transmission and does not belong to slots corresponding to the V2X resource pool.

The difference between the subframes or slots in the physical sense or those in the logical sense is illustrated by a typical application scenario below: when calculating the time-domain gap between two specific channels/messages (e.g., a physical sidelink shared channel (PSSCH) carrying sidelink data and a physical sidelink feedback channel (PSFCH) carrying corresponding feedback information), and it is assumed that the gap is N slots, if calculating subframes or slots in the physical sense, the N slots correspond to the absolute time length of N*x milliseconds in time domain, and x is the time length of a physical slot (subframe) under the numerology of the scenario, in milliseconds; otherwise, if calculating subframes or slots in the logical sense, taking a sidelink resource pool defined by a bitmap as an example, the gap of N slots correspond to N slots indicated as “1” in the bitmap, and the absolute time length of the gap varies with the specific configuration of the sidelink communication resource pool, rather than a fixed value.

Further, a slot in the present specification may be a complete slot or several symbols corresponding to a sidelink communication in a slot. For example, when the sidelink communication is configured to be performed on the X1-X2-th symbols in each slot, in this scenario, a slot in the following embodiments refers to the X1-X2-th symbols in a slot; for another example, when the sidelink communication is configured to be transmitted in a mini-slot, in this scenario, a slot in the following embodiments refers to the mini-slot defined or configured in the sidelink system, rather than the slot in the NR system; for still another example, when the sidelink communication is configured as symbol-level transmission, in this scenario, a slot in the embodiments may be replaced by a symbol, or may be replaced by N symbols which are time-domain granularity of the symbol-level transmission.

In order to make the purpose, technical schemes and advantages of the present application more clear, the implementations of the present application will be further described in detail with reference to the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In the sidelink communication system of wireless communication systems (for example, LTE and NR), the sidelink communication system is mainly designed based on the requirements of specific D2D and vehicle business scenarios, and the frequency bands used by it are mainly concentrated in specific licensed frequency bands, such as ITS frequency bands dedicated to vehicle traffic. With the development of the 5G technology, the commercial mode of sidelink communication is growing, so it is necessary to enhance the sidelink communication technology so that it can be applied to a wider range of application scenarios, such as XR, IIoT, RedCap and so on. For the service requirements of some future application scenarios, the transmission rate, delay and reliability that the current sidelink communication technology can achieve need to be further enhanced. A feasible method is to apply sidelink communication to more frequency bands, such as unlicensed frequency bands, increase the transmission rate that can be supported by the sidelink system and improve the reliability by increasing the bandwidth, and reduce the service transmission delay through high-frequency communication. However, the possibility of sidelink communication in unlicensed frequency bands has not been discussed in the current sidelink communication system, and any enhancement mechanism for unlicensed frequency bands has not been introduced.

In the traditional wireless communication system, the positioning technology is achieved mainly based on the signal/channel for positioning that the UE receives from or transmits to the base station, so the positioning function of the UE depends on the distribution of the base station and the network coverage, and the cost of the network layout is high. For example, the positioning accuracy of the UE is poor when the network layout is sparse, and it is difficult to realize the positioning function when it is outside the cell coverage. Therefore, the introduction of positioning technology based on sidelink communication can effectively improve the applicable scenarios of positioning technology and improve the positioning accuracy in most scenarios. However, the current wireless communication system does not support the sidelink based positioning technology.

In the LTE sidelink communication system and the NR V2X system of Release 16, the frequency-domain resources for sidelink communication are usually located in the licensed frequency band. Generally, it is assumed that there is basically no interference from other external communication systems (such as WiFi, Bluetooth, etc.) on the frequency band. However, for the sidelink communication system operating in the unlicensed frequency band, it is necessary to consider the interference of other communication systems to sidelink communication on the unlicensed carrier, and it is also necessary to limit the interference of sidelink communication to other communication systems according to regulation.

In the NR unlicensed (NR-U) system of Releases 15 and 16, listen before talk (LBT) is adopted as one of the typical technologies in unlicensed frequency bands. In this technology, a special frame structure is defined for NR communication systems in unlicensed frequency bands, and the frame structure contains several gaps for LBT. The UE and the base station need to perform LBT before uplink and downlink transmission, and can normally transmit various wireless signals and/or channels only after the LBT passes. In the specification, a method of using the LBT technology for the sidelink communication system is provided.

In the communication system in the unlicensed frequency band, channel occupancy (CO) refers to transmission on the corresponding channel after the base station/UE performs the channel access procedure, and a channel occupancy time (COT) refers to a total time for transmission on the corresponding channel after the base station/UE and base stations/UEs sharing the channel occupancy perform the channel access procedure. Both the base station and/or the sidelink UE can initialize a COT and share the COT with other base stations and/or sidelink UEs. After initializing a COT or acquiring a COT shared by the base station/other nodes, the UE needs to determine the structure and location of sidelink resources in the COT. In the specification, a specific method for the UE to determine the structure and location of sidelink resources in the COT is illustrated.

In the NR-unlicensed (NR-U) technology, the structure of uplink/downlink resources in the COT can be embodied by an uplink/downlink burst, where the uplink/downlink burst is a transmission set from a base station or UE, and there is no gap exceeding a specific length. Similar to the definition of uplink/downlink bursts in the NR-U technology, the structure of sidelink resources in the COT can also be embodied by a sidelink burst, where the sidelink burst is a transmission set from a UE, and there is no gap exceeding a specific length (for example, 16 us). Optionally, only transmissions from the same UE are included in a burst; or, transmissions from the same or different UE may be included in a burst. Optionally, only one or more specific signals and/or channels are included in a burst; for example, only a physical sidelink control channel (PSCCH) and/or PSSCH is included in a burst, and only a PSFCH is included in another burst, or the PSCCH, PSSCH and PSFCH may be included in a burst. Optionally, similar to the discovery burst in the NR-U technology, the sidelink synchronization signal, the sidelink synchronization channel, and the sidelink reference signal (which may be a specific type of reference signal/a reference signal satisfying a specific condition) correspond to the sidelink discovery burst instead of the general sidelink burst.

In the sidelink communication technology, from the perspective of resource allocation, the 5G sidelink communication system includes two modes: a resource allocation mode based on base station scheduling and a resource allocation mode in which UE selects independently. In the 5G V 2 X system, the resource allocation mode based on base station scheduling and the resource allocation mode in which UE selects independently are referred to as mode 1 and mode 2 respectively. For resource allocation mode 2, a method for selecting resources by a sidelink UE independently is that the UE maintains monitoring and caching a sidelink resource pool, and before sidelink transmission that is required to be transmitted, determines a channel sensing time window and a resource selection time window according to a time range in which the sidelink transmission is expected to be transmitted, performs channel sensing in the channel sensing time window, excludes sidelink resources reserved by other sidelink UEs in the resource selection time window according to a result of the channel sensing, and randomly selects resources for sidelink transmission in sidelink resources not excluded in the resource selection time window. When the mechanism runs in the unlicensed frequency band, it needs to be modified accordingly due to the characteristics of the unlicensed frequency band itself, so as to adapt to the uncertainty due to the channel pre-emption mechanism based on COT sharing and LBT in the unlicensed frequency band, and make the operation of sidelink communication in the unlicensed frequency band not violate the restrictions of regulations.

In the specification, a UE obtains a predefined/(pre-)configured parameter, including at least one of obtaining from a higher layer, obtaining from a base station and obtaining from other UEs. For example, a second UE indicates a parameter to a first UE through high layer signaling and/or physical layer signaling, which can be understood in the specification as that the first UE acquires a configuration of the parameter from the second UE.

FIG. 4 illustrates a flowchart of a method according to various embodiments of the present disclosure.

In some embodiments, a method of adjusting a contention window (CW) for sidelink communication in an unlicensed frequency band is provided.

In the unlicensed frequency band, normally, a UE or base station can't directly transmit wireless transmission, but needs to determine whether a channel is idle first, and then can perform the wireless transmission after occupying the idle channel. The operation of determining whether the channel is idle and occupying the channel may be realized by the UE or the base station performing LBT. If the base station or UE needs to transmit a transmission, it first senses whether the channel is IDLE for a period of time, and it transmits the transmission only if the channel is idle. A length of the period of time may be determined based on a contention window parameter CWₚ, for example, in NR-U, the contention window is CW_{min,p}≤CWₚ≤CW_{max,p}, and the contention window may be adjusted based on a transmission status of the UE or the base station (for example, received hybrid automatic repeat request-acknowledge (HARQ-ACK)).

In the embodiment, before transmitting a sidelink signal and/or channel, the UE determines a contention window for listen before talk (LBT) and/or determines whether and how to adjust the contention window; the UE performs the LBT based on the contention window to acquire a channel to transmit the sidelink signal and/or channel.

Optionally, if the UE transmits the sidelink signal and/or channel, and the sidelink signal and/or channel includes at least a PSSCH and/or a PSCCH, the UE maintains the contention window (for example, maintaining the contention window parameter CWₚ) and determines whether and/or how to adjust the contention window or CWₚ before performing sidelink channel access. Optionally, the UE maintains or determines the contention window parameter CWₚ based on a channel access priority class (CAPC) associated with the PSSCH and/or the PSCCH (the following illustration is based on determination, but it can also be replaced by maintenance), and/or determines whether and/or how to adjust CWₚ.

The determination of the contention window parameter CWₚ and whether and/or how to adjust CWₚ may be considered as a part of a contention window adjustment procedure. For example, the contention window adjustment procedure includes that for each CAPC, when a transmission corresponding to the CAPC is transmitted for the first time, the UE determines the contention window parameter CWₚ; and/or, the contention window adjustment procedure includes that for each CAPC, the UE maintains CWₚ corresponding to the CAPC, and the maintenance includes determining whether and/or how to adjust CWₚ.

Optionally, the UE determines whether and/or how to adjust the contention window and/or determines the contention window parameter CWₚ based on at least one of the following; and it further includes that the UE determines the contention window parameter CWₚ and/or determines whether and/or how to adjust the contention window based on at least one of the following and the CAPC:
a cast type, further including at least one of: unicast, groupcast and broadcast; optionally, the cast type includes a cast type of transmission transmitted by the UE and/or a cast type of transmission received by the UE from other UEs;
a HARQ-ACK option, further including at least one of: HARQ-ACK feedback being disabled, and HARQ-ACK feedback being enabled; if the cast type is groupcast, the HARQ-ACK option further includes at least one of: a groupcast HARQ-ACK option with negative acknowledgement (NACK)-only feedback, and a groupcast HARQ-ACK option with both NACK and ACK feedback; for example, the HARQ-ACK option includes the groupcast HARQ-ACK option with NACK-only feedback being enabled, the groupcast HARQ-ACK option with both NACK and ACK feedback being enabled, and HARQ-ACK feedback being disabled; optionally, the cast type includes a HARQ-ACK option of transmission transmitted by the UE and/or a HARQ-ACK option of transmission received by the UE from other UEs;
a HARQ-ACK status corresponding to PSCCH and/or PSSCH transmission transmitted by the UE (for example, a HARQ-ACK status fed back to the UE by other UEs after the UE transmits the PSCCH and/or PSSCH) being determined as ACK or NACK; and/or, the HARQ-ACK status corresponding to the PSCCH and/or PSSCH transmission being determined as ACK or NACK or DTX (this status indicates that ACK and/or NACK are not received); further, in a specific time range, an extent of the HARQ-ACK status corresponding to the PSCCH and/or PSSCH transmission transmitted by the UE, for example, whether a number and/or ratio of HARQ-ACK statuses determined as ACK and/or NACK (or ACK and/or NACK and/or DTX) is in a predetermined/(pre-)configured threshold range;
a HARQ-ACK status transmitted by the UE to other UEs (for example, a HARQ-ACK status corresponding to PSCCH and/or PSSCH transmission transmitted by other UEs to the UE) is set to ACK or NACK, or the HARQ-ACK feedback is disabled for the transmission of other UEs; further, in a specific time range, an extent of the HARQ-ACK status corresponding to the PSCCH and/or PSSCH transmission from other UEs, for example, whether a number and/or ratio of HARQ-ACK statuses determined as ACK and/or NACK (or ACK and/or NACK and/or DTX) is in a predetermined/(pre-)configured threshold range;
a sidelink measurement result, such as a measurement result of a channel, further including at least one of the following measurements: a reference signal received power (RSRP), a received signal strength indicator (RSSI), and a channel busy ratio (CBR); for example, whether to adjust the contention window and/or a method used and/or a parameter for adjustment when adjusting the contention window is determined based on whether a result of at least one of the above measurements is in a predetermined/configured threshold range; optionally, the measurement result of the channel includes a measurement result in a predetermined/(pre-)configured time range, which may be determined based on the sidelink signal and/or channel and/or based on preset/ (pre-)configured information;
a service priority, including a priority indicated by a priority field in sidelink control information (SCI); optionally, the contention window adjustment based on the CAPC in the specification may also be replaced by contention window adjustment based on the priority, and for example, for each CAPC/priority, the UE maintains its corresponding contention window parameter CWₚ and/or determines whether and/or how to adjust the contention window.

Optionally, the transmission transmitted by the UE (and/or the transmission received by the UE from other UEs) may be the same as or different from the sidelink signal and/or channel including at least the PSCCH and/or PSSCH transmitted by the UE.

Optionally, at least one of the above items includes at least one of the above items within a given time length, and/or at least one of the above items after the last update of the contention window (including adjusting the contention window and/or maintaining the contention window and/or resetting the contention window), for example, at least one of the cast type corresponding to the PSCCH and/or PSSCH transmitted by the UE, the HARQ-ACK option corresponding to the PSCCH and/or PSSCH transmitted by the UE, and the HARQ-ACK status corresponding to the PSCCH and/or PSSCH transmitted by the UE after the last update of the contention window.

Optionally, the given time length may be referred to as a reference duration, which is determined according to the channel occupancy initialized or shared by the UE. Optionally, the reference duration corresponds to the channel occupancy, which is channel occupancy initiated by the UE or shared by other UEs, and includes at least one of the transmission transmitted by the UE, the transmission received by the UE from other UEs, and the transmission used by the UE to maintain the contention window for sidelink channel access. Optionally, the reference duration corresponding to the channel occupancy starts from a start position of the channel occupancy and ends at an end position of a transmission resource of at least one sidelink signal and/or channel (which may be a specific type of sidelink signal and/or channel, such as PSSCH) (further, if the transmission resource includes multiple time units, such as multiple slots, it may be an end position of the first time unit or the last time unit), and/ or ends at an end position of a transmission resource of a burst of at least one sidelink signal and/or channel (which may be a specific type of sidelink signal and/or channel, such as PSSCH) (further, if the transmission resource includes multiple time units, such as multiple slots, it may be an end position of the first time unit or the last time unit); for example, it ends at an earlier position between the above two. A cluster of sidelink signals and/or channels may be one or more sidelink signals and/or channels transmitted and/or received by the UE in multiple consecutive time units, for example, a cluster of sidelink signals and/or channels is multiple PSSCHs (and associated PSCCHs) transmitted by the UE in multiple selected consecutive slots, and further, the multiple PSSCHs may correspond to different data.

Optionally, the method for the UE to use the HARQ-ACK status transmitted to other UEs to determine the contention window parameter CWₚ and/or determine whether and/or how to adjust the contention window may also include that the UE does not use the HARQ-ACK status that does not need to be transmitted (for example, for the transmission without enabling HARQ-ACK feedback) in the contention window adjustment procedure, and/or includes that the UE uses information on whether the transmission from other UEs is successfully received to determine the contention window parameter CWₚ and/or determine whether and/or how to adjust the contention window. This is because the UE will not always feed back the HARQ-ACK status which embodies whether the transmission from other UEs is successfully received to the other UEs. For example, for the case of broadcast transmission, transmission with HARQ-ACK feedback disabled, and successful reception of transmission with the groupcast HARQ-ACK option with NACK-only feedback enabled, the UE will not transmit the HARQ-ACK feedback. However, the information on whether the transmission is successfully received may still feed back the interference status on the channel, so although the information is not actually transmitted, it may still be used in the process of determining the contention window parameter CWₚ and/or determining whether and/or how to adjust the contention window.

Optionally, in the above method, the UE uses the HARQ-ACK status corresponding to the PSCCH and/or PSSCH transmission transmitted by the UE to determine the contention window parameter CWₚ and/or determine whether and/or how to adjust the contention window. The method further includes that the UE determines the HARQ-ACK status of the PSCCH and/or PSSCH transmission transmitted by the UE based on at least one of the cast type, the HARQ-ACK option and the status indicated by the received HARQ-ACK feedback corresponding to the PSCCH and/or PSSCH transmission. Further, it includes at least one of:
if the cast type is broadcast, and/or if the HARQ-ACK feedback is disabled for the transmission, in the contention window adjustment procedure, setting the HARQ-ACK status of the transmission to ACK, or to NACK, or not using the transmission;
if the cast type is groupcast and/or the groupcast HARQ-ACK option with NACK-only feedback is enabled for the transmission, in the contention window adjustment procedure, when NACK corresponding to the transmission is received, setting the HARQ-ACK status of the transmission to NACK, otherwise, setting the HARQ-ACK status of the transmission to ACK;
if the cast type is groupcast and/or the groupcast HARQ-ACK option with both ACK and NACK feedback is enabled for the transmission, in the contention window adjustment procedure, for at least one transmission and/or retransmission of the PSCCH and/or PSSCH, when all ACKs corresponding to the transmission are received (for example, a total of at least one ACK transmitted by each expected receiving UE is received and/or at least one ACK is received at each expected PSFCH receiving occasion), setting the HARQ-ACK status of the transmission to ACK, otherwise, setting the HARQ-ACK status of the transmission to NACK; the method is similar to the method of determining the HARQ-ACK status when the HARQ-ACK feedback of sidelink transmission is reported to the base station through the uplink channel;
if the cast type is groupcast, and/or the groupcast HARQ-ACK option with both ACK and NACK feedback is enabled for the transmission, in the contention window adjustment procedure, when all ACKs corresponding to the transmission are received (for example, a total of at least one ACK transmitted by each expected receiving UE is received), setting the HARQ-ACK status of the transmission to ACK, otherwise, setting the HARQ-ACK status of the transmission to NACK. The difference between this method and the previous method is whether to determine the ACK received in multiple retransmissions cumulatively. For example, for an expected receiving UE, for the N transmissions/retransmissions of the PSCCH and/or PSSCH in the previous method, as long as there is at least one ACK in the corresponding N HARQ-ACK statuses, it may be considered that an ACK is received from the expected receiving UE; in this method, for each transmission of the PSCCH and/or PSSCH, it is determined whether the ACK transmitted by each expected receiving UE is received respectively, regardless of the previous reception status. This method is because, when the purpose of determining the HARQ-ACK status of transmission is to determine whether the PSCCH/PSSCH needs to be retransmitted, for each expected receiving UE, as long as the UE successfully receives the PSCCH/PSSCH at least once, there is no need to trigger retransmission for the UE; however, when the purpose of determining the HARQ-ACK status of the transmission is to adjust the contention window, the purpose of the HARQ-ACK status is to feed back the status of the channel interference corresponding to the current transmission. Therefore, although an expected receiving UE has successfully received the PSCCH/PSSCH before, if the UE does not provide the HARQ-ACK feedback of the currently transmitted PSCCH/ PSSCH, it indicates that the UE may still fail to successfully decode the sidelink control information SCI of the current transmission, thus indicating that there may be interference in the current channel. Therefore, the method of determining the HARQ-ACK status for each retransmission of PSCCH/PSSCH respectively to adjust the contention window is beneficial to accurately determine the current channel interference status;
if the cast type is groupcast, and/or the groupcast HARQ-ACK option with both ACK and NACK feedback is enabled for the transmission, in the contention window adjustment procedure, for at least one transmission and/or retransmission of the PSCCH and/or PSSCH, when at least one ACK corresponding to the transmission is received or when the number of received ACKs corresponding to the transmission exceeds a given threshold, setting the HARQ-ACK status of the transmission to ACK, otherwise, setting the HARQ status of the transmission to NACK; this method is different from the method of determining the HARQ-ACK status when the HARQ-ACK feedback of sidelink transmission is reported to the base station through the uplink channel, and the main technical reason is that the HARQ-ACK reported to the base station is used to determine whether the UE still needs retransmission resources, so as long as any receiving UE does not transmit an ACK, the transmitting UE requests resources to retransmit data for the receiving UE. In the contention window adjustment procedure, the HARQ-ACK feedback is mainly used as reference information to determine whether the channel in the unlicensed frequency band is successfully accessed, so when a certain number of ACKs are received, the transmitting UE can consider that the channel access is successful, but some UEs may feedback NACK due to other factors (such as conflicts within the sidelink communication system and in-accurate transmission power control).
if the cast type is groupcast, and/or the groupcast HARQ-ACK option with both ACK and NACK feedback is enabled for the transmission, in the contention window adjustment procedure, for any transmission and/or retransmission of the PSCCH and/or PSSCH, when at least one ACK corresponding to the transmission is received or when the number of received ACKs corresponding to the transmission exceeds a given threshold, setting the HARQ-ACK status of the transmission to ACK, otherwise, setting the HARQ status of the transmission to NACK. The difference between this method and the previous method is whether to determine the ACK received in multiple retransmissions cumulatively, which is similar to the technical difference between the previous other two methods.

Optionally, the UE determining the contention window parameter CWₚ includes determining at least one of: a minimum value of CWₚ, a maximum value of CWₚ, a set of values of CWₚ, and an initial value of CWₚ in the contention window adjustment procedure. Further, at least one of the contention window parameters CWₚ corresponding to at least one CAPC is included.

Optionally, the UE determining how to adjust the contention window includes determining at least one of the following in the contention window adjustment procedure:
an initial value of CWₚ in the contention window adjustment procedure; further, an initial value of CWₚ corresponding to at least one CAPC in the contention window adjustment procedure (including a value to which CWₚ is set in the first step in the contention window adjustment procedure, and/or an initial value adopted when the sidelink signal and/or channel corresponding to at least one CAPC is transmitted for the first time, and/or a specific value when the value of CWₚ is reset to the specific value when CWₚ is equal to the maximum value CW_{max,p} of CWₚ for K consecutive times);
an amplitude by which CWₚ is adjusted in the contention window adjustment procedure; further, the amplitude by which CWₚ corresponding to at least one CAPC is adjusted in the contention window adjustment procedure; for example, when the UE adjusts CWₚ, based on the current value of CWₚ, the value of CWₚ is set to the next larger N-th value in the set of values of CWₚ, and the UE determining how to adjust the contention window includes determining the value of N (for example, if the UE adjusts CWₚ, the UE determines to set its value to the next larger value, or the next larger second value, or the next larger N-th value); for another example, when the UE adjusts CWₚ, it increases its value by X, and the UE determining how to adjust the contention window includes determining the value of X;
adjusting CWₚ corresponding to which CAPCs in the contention window adjustment procedure;
a number of times for which CWₚ is consecutively maintained at the maximum value; for example, if CWₚ (optionally, corresponding to at least one CAPC) is equal to the maximum value CW_{max,p} of CWₚ for K consecutive times in the contention window adjustment procedure, the value of CWₚ (optionally, corresponding to at least one CAPC) is set as the minimum value CW_{min,p} of CWₚ, and the number of times for which CWₚ is consecutively maintained at the maximum value is the value of K;
whether to set CWₚ to a specific value, or whether to set CWₚ to a larger (or smaller) value between the specific value and the current value; the specific value may be predetermined and/or (pre-)configured, including predetermined and/or (pre-)configured based on the CAPC and/or the priority of the sidelink signal and/or channel.

Optionally, if the UE determines how to adjust the contention window at least according to the HARQ-ACK status (including the HARQ-ACK status corresponding to the PSCCH and/or PSSCH transmission transmitted by the UE and/or the HARQ-ACK status transmitted by the UE to other UEs), the method further includes: according to the ratio and/or number of specific HARQ-ACK statuses (such as ACK or NACK) and/or the number of times for which specific HARQ-ACK statuses are consecutively transmitted and/or received (for example, the HARQ-ACK statuses of N consecutive PSCCH and/or PSSCH transmissions are all NACK) in a certain time range, at least one of the initial value of CWₚ in the contention window adjustment procedure, the amplitude by which CWₚ is adjusted in the contention window adjustment procedure, adjusting CWₚ corresponding to which CAPCs and number of times for which CWₚ is consecutively maintained at the maximum value is determined. For example, if it is determined to adjust CWₚ, and for the PSCCH and/or PSSCH transmission transmitted by the UE, if the HARQ-ACK status is determined to be NACK for more than N consecutive times, the adjustment amplitude of CWₚ is a larger value; otherwise, the adjustment amplitude of CWₚ is a smaller value. For another example, in a certain time range, if the ratio in which HARQ-ACK status is NACK is higher than the first threshold, the adjustment amplitude of CWₚ is a larger value; otherwise, if the ratio in which HARQ-ACK status is NACK is not higher than the first threshold and is higher than the second threshold, the adjustment amplitude of CWₚ is a smaller value; otherwise, if the ratio in which the HARQ-ACK status is NACK is not higher than the second threshold, CWₚ is not adjusted; the ratio in the example may also be replaced by the number.

Optionally, the UE determining the contention window parameter CWₚ based on at least one of the above items (cast type, HARQ-ACK option, HARQ-ACK status, measurement result) includes using at least one of the following methods:
determining the CAPC of the sidelink signal and/or channel based on at least one of the above items, and determining CWₚ according to the CAPC; for example, under the condition that other CAPC-related parameters are the same, the sidelink signal and/or channel meeting one of the above items and the sidelink signal and/or channel not meeting one of the above items correspond to different CAPCs, or the sidelink signal and/or channel meeting one of the above items and meeting another one of the above items correspond to different CAPCs;
based on the CAPC of the sidelink signal and/or channel, and/or based on whether the sidelink signal and/or channel meets at least one of the above items, determining CWₚ (including determining at least one of the minimum value of CWₚ, the maximum value of CWₚ, the set of values of CWₚ, and the initial value of CWₚ in the contention window adjustment procedure); for example, the sidelink signal and/or channel of the same CAPC corresponds to different CWₚ when meeting one of the above items and not meeting one of the above items, or when meeting one of the above items and meeting another one of the above items.

Optionally, the UE determining how to adjust the contention window based on at least one of the above items (cast type, HARQ-ACK option, HARQ-ACK status, measurement result) includes using at least one of the following methods:
determining the CAPC of the sidelink signal and/or channel based on at least one of the above items, and determining how to adjust the contention window corresponding to the CAPC according to the CAPC;
determining how to adjust the contention window based on the CAPC of the sidelink signal and/or channel, and/or based on whether the sidelink signal and/or channel meet at least one of the above items; further, determining at least one of the initial value of CWₚ in the contention window adjustment procedure, the amplitude by which CWₚ is adjusted in the contention window adjustment procedure, adjusting CWₚ corresponding to which CAPCs in the contention window adjustment procedure, and the number of times for which CWₚ is consecutively maintained at the maximum value.

Optionally, the UE determines whether to use any of the above methods based on (pre-)configuration, for example, the UE uses one or more methods if it is configured to use the one or more methods, otherwise it uses another one or more methods.

Optionally, if the UE determines more than one method to adjust the contention window (for example, based on the HARQ-ACK status of different transmissions, multiple amplitudes by which the contention window is adjusted are determined respectively), then the contention window adjustment procedure is performed by using at least one of the following measures:
when multiple methods correspond to different adjustment amplitudes or adjusted values of the contention window, a smaller adjustment amplitude/adjusted value is used;
when multiple methods correspond to different adjustment amplitudes or adjusted values of the contention window, a larger adjustment amplitude/adjusted value is used;
when multiple methods correspond to adjustment or no adjustment, the contention window is determined according to the method for adjustment.

In an exemplary embodiment, the UE determining whether and/or how to adjust the contention window according to at least one of the above information includes at least one of:
if (optionally, after the last update of the contention window) the UE acquires a valid sidelink HARQ-ACK feedback, which includes at least one NACK, and the at least one NACK corresponds to a groupcast sidelink transmission for which the groupcast HARQ-ACK option with NACK-only feedback is enabled, the UE adjusts the contention window; optionally, the method for adjusting the contention window includes at least one of: using the same method as adjusting the contention window based on other conditions/methods/information, such as increasing the value of the contention window to the next higher allowable value; or using different methods, including using a larger adjustment amplitude, such as increasing the value of the contention window to the next second or N-th higher allowable value; or using different methods, including using a smaller adjustment amplitude. For example, if the UE consecutively or totally transmits a sidelink transmission for which the groupcast HARQ-ACK option with NACK-only feedback is enabled for K times and acquires at least one NACK corresponding to the transmission, the value of the contention window is increased to the next first or N-th higher allowable value (further, the method for adjusting the contention window corresponding to the first K-1 transmissions is to maintain the contention window at the current value, and the method for adjusting the contention window corresponding to the K-th transmission is to increase the value of the contention window to the next first or N-th higher allowable value); where K and N are predetermined or (pre-)configured parameters;
if (optionally, after the last update of the contention window) the UE transmits a sidelink transmission for which the groupcast HARQ-ACK option with NACK-only feedback is enabled, and fails to acquire an effective sidelink HARQ-ACK feedback corresponding to the transmission, then: the UE maintains the contention window at the current value; or the UE adjusts the contention window and uses the same method as adjusting the contention window based on other conditions/methods/information; or the UE adjusts the contention window and uses different methods, including using a smaller adjustment amplitude. For example, if the UE consecutively or totally transmits a sidelink transmission for which the groupcast HARQ-ACK option with NACK-only feedback is enabled for K times and fails to acquire an effective sidelink HARQ-ACK feedback corresponding to the transmission, the value of the contention window is increased to the next first or N-th higher allowable value; or, the UE further determines whether and how to adjust the contention window based on the results of sidelink measurement (including at least one of sidelink CBR measurement, sidelink RSSI measurement and sidelink RSRP measurement); where K and N are predetermined or (pre-)configured parameters;
if (optionally, after the last update of the contention window) the UE acquires an effective sidelink HARQ-ACK feedback, which includes ACK, and the number or ratio of ACKs exceeds a given threshold, and the ACK corresponds to the groupcast sidelink transmission for which the groupcast HARQ-ACK option with both NACK and ACK feedback is enabled, the UE sets the contention window to a specific value, for example, the minimum value of the contention window; otherwise, optionally, the UE adjusts the contention window, including increasing the value of the contention window to the next first or N-th higher allowable value; the ratio of ACKs exceeding the given threshold further includes: when the number of receiving UEs expected by the groupcast is X and the number of HARQ-ACK feedbacks expected to be received by the UE is X, the number of ACKs divided by X exceeds the given threshold; exceeding the given threshold may also be replaced by meeting the given threshold range; optionally, if at least one receiving UE corresponding to the groupcast sidelink transmission for which the groupcast HARQ-ACK option with both NACK and ACK feedback is enabled transmitted by the UE has transmitted ACK feedback for the data corresponding to the transmission (this condition mainly corresponds to the situation that the current transmission is the N-th retransmission of the data, so the receiving UE may have provided ACK/NACK feedback in the previous N-1 transmissions/retransmissions), regardless of whether the receiving UE has transmitted ACK feedback corresponding to the transmission, it is processed as ACK feedback;
if (optionally, after the last update of the contention window) the UE transmits a sidelink signal and/or channel for which HARQ-ACK feedback is disabled (optionally, a PSCCH and/or PSSCH for which HARQ-ACK feedback is disabled), then: the UE maintains the contention window at the current value; or the UE sets the contention window to a specific value, which may be predetermined and/or (pre-)configured, including predetermined and/or (pre-)configured based on the CAPC and/or the priority of the sidelink signal and/or channel, and may be a value in a set of possible values of the contention window (where, optionally, after consecutively or totally transmitting a sidelink signal and/or channel for which HARQ-ACK feedback is disabled for N times, the UE sets the contention window to a specific value or to a larger (or smaller) value between the specific value and the current value); or sets the contention window to a larger (or smaller) value between the specific value and the current value; or the UE adjusts the contention window and uses the same method as adjusting the contention window based on other conditions/methods/information; or the UE adjusts the contention window and uses different methods, including using a smaller adjustment amplitude. For example, if the UE consecutively or totally transmits a sidelink transmission for which HARQ-ACK feedback is disabled for K times and fails to acquire an effective sidelink HARQ-ACK feedback corresponding to the transmission, the value of the contention window is increased to the next first or N-th higher allowable value; or the UE further determines whether and how to adjust the contention window based on the results of sidelink measurement (including at least one of sidelink CBR measurement, sidelink RSSI measurement and sidelink RSRP measurement).

Optionally, the UE adjusts the contention window based on transmissions within a given time length (which may be referred to as a reference duration), including adjusting the contention window based on transmissions of more than one HARQ-ACK option within the given time length. For example, the UE transmits transmissions using the following at least two HARQ-ACK options within the reference duration: transmissions (and/or broadcast transmissions) for which HARQ-ACK feedback is disabled, transmissions for which HARQ-ACK feedback is enabled (further, unicast transmissions for which HARQ-ACK feedback is enabled), groupcast transmissions for which the groupcast HARQ-ACK option with NACK-only feedback is enabled, and groupcast transmissions for which the groupcast HARQ-ACK option with both NACK and ACK feedback is enabled. The UE adjusts the contention window based on the transmission of the at least two HARQ-ACK options.

Further, at least one of the following methods is included:
the UE determines whether and how to adjust the contention window based on the transmission corresponding to one HARQ-ACK option within a given time length, and determines whether and how to adjust the contention window according to various ways of whether and how to adjust the contention window respectively corresponding to the more than one HARQ-ACK option;
the UE selects one HARQ-ACK option for adjusting the contention window based on more than one HARQ-ACK option within a given time length, and determines whether and how to adjust the contention window based on the selected HARQ-ACK option;
the UE determines whether and how to adjust the contention window based on the HARQ-ACK feedback (which may be the expected HARQ-ACK feedback and/or the HARQ-ACK feedback received by the UE) corresponding to more than one HARQ-ACK option within a given time length.

Optionally, for the UE determining whether and how to adjust the contention window based on the transmission corresponding to one HARQ-ACK option within a given time length, and determining whether and how to adjust the contention window according to various ways of whether and how to adjust the contention window respectively corresponding to the more than one HARQ-ACK option, the method further includes at least one of:
if the way of adjusting the contention window corresponding to at least one HARQ-ACK option includes setting the value of the contention window CWₚ to the minimum value CW_{min,p} of CWₚ, setting the value of the contention window CWₚ to the minimum value CW_{min,p} of CWₚ;
if the way of adjusting the contention window corresponding to at least one HARQ-ACK option includes increasing the value of the contention window CWₚ, CWₚ is increased; optionally, if M HARQ-ACK options correspond to increase of the value of the contention window CWₚ, the value of CWₚ is set to the next larger N-th value in the set of values of CWₚ, and M=N or the mapping relationship between M and N is preset/(pre-)configured; the increase in this method may also be similarly replaced by the decrease;
if the way of adjusting the contention window corresponding to at least one HARQ-ACK option includes maintaining the value of the contention window CWₚ unchanged, the value of the contention window CWₚ is maintained unchanged.

Optionally, there is an order in the use of the above methods, for example: firstly, determining whether there is at least one way of adjusting the contention window corresponding to the HARQ-ACK option includes setting the value of the contention window CWₚ to the minimum value CW_{min,p} of CWₚ, and if there is one way, the value of the contention window CWₚ is set to the minimum value CW_{min,p} of CWₚ; otherwise, determining whether there is at least one way of adjusting the contention window corresponding to the HARQ-ACK option includes increasing the value of the contention window CWₚ, if there is one way, CWₚ is increased, otherwise determining whether there is at least one way of adjusting the contention window corresponding to the HARQ-ACK option includes maintaining the value of the contention window CWₚ unchanged, if there is one way, the value of the contention window CWₚ is maintained unchanged.

The above method is used when there are multiple HARQ-ACK options within a given time length. Similarly, when there are multiple transmissions within a given time length and multiple transmissions correspond to different methods for adjusting the contention window, the above method can also be used. Optionally, the UE adjusts the contention window based on the transmission within a given time length (which may be referred to as a reference duration), including when the UE transmits multiple transmissions within the given time length, how to adjust the contention window based on whether and how to adjust the contention window corresponding to each (or at least one) transmission of the multiple transmissions. The specific method is similar to the above-mentioned method that the UE determines whether and how to adjust the contention window based on the transmissions of different HARQ-ACK options within a given time length, so as to determine whether and how to adjust the contention window.

Optionally, for the UE selecting one HARQ-ACK option for adjusting the contention window based on more than one HARQ-ACK option within a given time length, and determining whether and how to adjust the contention window based on the selected HARQ-ACK option, the method further includes at least one of:
according to the preset or (pre-)configured order of selecting HARQ-ACK options, a HARQ-ACK option is selected for adjusting the contention window. For example, the order is unicast transmission for which HARQ-ACK feedback is enabled>groupcast transmission for which groupcast HARQ-ACK option with both NACK and ACK feedback is enabled>groupcast transmission for which groupcast HARQ-ACK option with NACK-only feedback is enabled>transmission (and/or broadcast transmission) for which HARQ-ACK feedback is disabled. Then the UE adjusts the contention window based on the unicast transmission for which HARQ-ACK feedback is enabled when the transmissions within a given time length include the unicast transmission for which HARQ-ACK feedback is enabled and other transmissions, otherwise, the UE adjusts the contention window based on the groupcast transmission for which groupcast HARQ-ACK option with both NACK and ACK feedback is enabled when the transmissions within a given time length include the groupcast transmission for which groupcast HARQ-ACK option with both NACK and ACK feedback is enabled and other transmissions, and so on;
according to whether the HARQ-ACK option includes ACK feedback and/or includes NACK feedback, a HARQ-ACK option is selected for adjusting the contention window. For example, the HARQ-ACK option including ACK feedback (for example, unicast HARQ-ACK feedback, groupcast HARQ-ACK feedback with both NACK and ACK feedback) is preferentially selected, and if there is no HARQ-ACK option including ACK feedback, the HARQ-ACK option including NACK feedback is preferentially selected (for example, groupcast HARQ-ACK feedback with NACK-only feedback), otherwise, the HARQ-ACK feedback disabled is selected;
according to whether the received feedback corresponding to the HARQ-ACK option includes ACK feedback and/or NACK feedback, a HARQ-ACK option is selected to adjust the contention window. For example, if the UE receives the ACK feedback, which corresponds to unicast HARQ-ACK feedback and/or groupcast HARQ-ACK feedback with both NACK and ACK feedback, the contention window is adjusted preferentially according to the method corresponding to unicast HARQ-ACK feedback and/or groupcast HARQ-ACK feedback with both NACK and ACK feedback;

Otherwise, if the UE receives the NACK feedback, which corresponds to unicast HARQ-ACK feedback and/or groupcast HARQ-ACK feedback with both NACK and ACK feedback and/or groupcast HARQ-ACK feedback with NACK-only feedback, the contention window is adjusted according to the method corresponding to unicast HARQ-ACK feedback and/or groupcast HARQ-ACK feedback with both NACK and ACK feedback and/or groupcast HARQ-ACK feedback with NACK-only feedback; otherwise, the contention window is adjusted according to the method corresponding to the HARQ-ACK feedback being disabled.

Optionally, for the UE determining whether and how to adjust the contention window based on the HARQ-ACK feedback (which may be the expected HARQ-ACK feedback and/or the HARQ-ACK feedback received by the UE) corresponding to more than one HARQ-ACK option within a given time length, the method further includes: determining whether and how to adjust the contention window based on whether the received feedback of a specific status meets a predetermined and/or (pre-)configured number threshold range and/or ratio threshold range.

Optionally, the method for adjusting the contention window includes at least one of:
when the feedback of a specific status exceeds the threshold of number and/or ratio, the value of the contention window CWₚ is set to the minimum value CW_{min,p} of CWₚ;
when the feedback of a specific status exceeds the threshold of number and/or ratio, the value of the contention window CWₚ is increased; optionally, when the first threshold is exceeded, CWₚ is increased to the N1-th larger value in the set of values, and when the second threshold is exceeded, CWₚ is increased to the N2-th larger value in the set of values, and so on; the mapping relationship between the X-th threshold and Nx is preset and/or pre-configured; in this method, the increase may also be replaced by the decrease (correspondingly, the larger value is replaced by the smaller value);
when the feedback of a specific status is lower than the threshold of number and/or ratio, the value of the contention window CWₚ is maintained unchanged.

For the description of whether it meets the threshold range in the above method, it can be replaced by exceeding, exceeding or equal to, lower than, lower than or equal to each other. The replacement can be based on the selection of a specific status, for example, ACK exceeding the threshold can be replaced by NACK below the threshold, and the physical meaning of both can be understood as that the reliability of communication is higher than a certain degree, which has a similar distinguishing effect.

The specific status may be at least one of ACK, NACK, ACK or NACK, and feedback not received (hereinafter referred to as DTX). Optionally, the specific status is determined based on the corresponding cast type, such as unicast for which HARQ-ACK is enabled and groupcast with both ACK and NACK feedback, and the specific status is ACK; this specific status is DTX, which corresponds to groupcast with NACK-only feedback. The ratio can be acquired by dividing the number of received feedbacks of a specific status by the number of corresponding feedbacks transmitted.

For example, for the groupcast HARQ-ACK option with both ACK and NACK feedback, one PSSCH transmission corresponds to N feedbacks (also known as N PSFCH receiving occasions, and the UE expects to receive one feedback at each PSFCH receiving occasion), and N corresponds to the number of UE at the receiving end of groupcast. For example, for groupcast with NACK-only feedback and unicast for which HARQ is enabled, one PSSCH transmission corresponds to one feedback. For example, for the transmission for which HARQ is disabled, one PSSCH transmission corresponds to 0 feedbacks or P feedbacks, where P is a preset and/or (pre-)configured value.

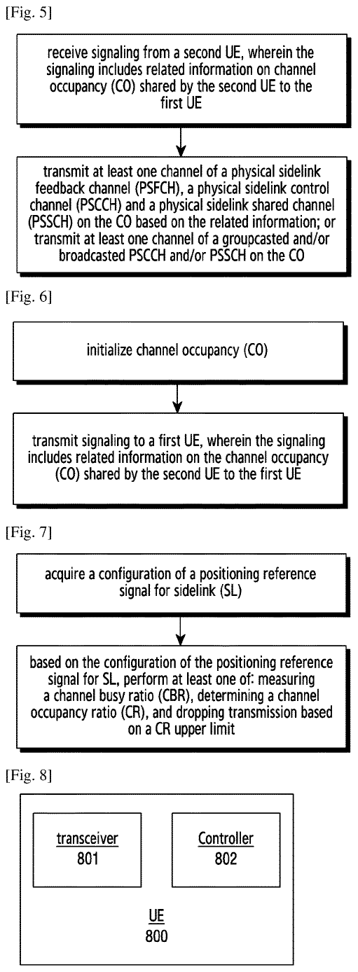

FIG. 5 illustrates another flowchart of a method according to various embodiments of the present disclosure. FIG. 6 illustrates another flowchart of a method according to various embodiments of the present disclosure.

For sidelink communication in unlicensed frequency bands, a typical scenario is that the first UE needs to initialize channel occupancy (CO) before it can transmit sidelink signals and/or channels on the initialized CO; and/or, the first UE needs to acquire the CO shared by the second UE to the first UE before transmitting the sidelink signal and/ or channel on the CO. Optionally, the CO is initialized by the second UE.

Optionally, if the first UE acquires the CO shared by the second UE to the first UE and transmits a sidelink transmission on the CO, the target UE (or the receiving UE) of the transmitted transmission includes at least the second UE, and may or may not include other UEs.

Optionally, if the first UE acquires the CO shared by the second UE to the first UE, the first UE determines at least one channel transmitted on the CO, including at least one of:
if the at least one transmitted channel is PSFCH, determining that the at least one channel can be transmitted on the CO,
if the at least one transmitted channel is PSCCH and/or PSSCH, whether the at least one channel can be transmitted on the CO is determined according to at least one of the cast type corresponding to the channel, whether the HARQ feedback is enabled or not, and the enabled HARQ-ACK feedback type.

Optionally, if the first UE acquires the CO shared by the second UE to the first UE, the first UE may transmit the PSFCH on the CO, and/or may not transmit the PSCCH and/or PSSCH on the CO; or, the first UE may transmit PSFCH, PSCCH and/or PSSCH on the CO.

Optionally, if the first UE acquires the CO shared by the second UE to the first UE, and the first UE may transmit the groupcasted and/or broadcasted PSCCH and/or PSSCH on the CO, and the target UE of the PSCCH and/or PSSCH includes other UEs different from the first UE and the second UE, then at least one of the following methods for transmitting groupcast and/or broadcast is also used:
if HARQ-ACK feedback is disabled for the transmission or the cast type of the transmission is broadcast, the first UE can transmit the transmission on the CO, otherwise it cannot transmit the transmission;
if a specific HARQ-ACK feedback type (for example, a groupcast HARQ-ACK feedback type with NACK-only feedback) is enabled for the transmission, the first UE can transmit the transmission on the CO, otherwise it cannot transmit the transmission;
the first UE can transmit the transmission on the CO. If HARQ-ACK feedback is enabled for the transmission, only the second UE can transmit the HARQ-ACK feedback on the CO, and other UEs cannot transmit the HARQ-ACK feedback on the CO. Accordingly, the first UE expects to receive the HARQ-ACK feedback from the second UE, and does not expect to receive the HARQ-ACK feedback transmitted by other receiving UE corresponding to the transmission. Further, if this method is used, the method for the first UE to determine whether the transmission is successful also needs to be adjusted accordingly, including at least one of the following: if a groupcast HARQ-ACK feedback type with NACK-only feedback is enabled for the transmission, the first UE considers the transmission as NACK if it receives NACK from the second UE, otherwise (if it does not receive HARQ-ACK feedback from the second UE), it considers the transmission as ACK; if the groupcast HARQ-ACK feedback type with both ACK and NACK feedback is enabled for the transmission, the first UE considers the transmission as ACK if it receives ACK from the second UE, otherwise (if it receives NACK from the second UE or does not receive HARQ-ACK feedback from the second UE), it considers the transmission as NACK.

Optionally, the first UE initializes the CO and shares it with the second UE, and the signaling indicating the sharing of the CO also indicates the types of signals and/or channels that the second UE can transmit on the CO, for example, whether the second UE can transmit PSCCH and/or PSSCH and/or whether it can transmit PSFCH on the CO; and/or indicate whether the second UE can transmit transmissions to other UEs on the CO, or indicate whether the second UE can transmit specific cast types (such as groupcast and/or broadcast and/or unicast) on the CO; and/or a method for indicating the second UE to transmit groupcast and/or broadcast on the CO, including at least one of the above methods. Optionally, the second UE determines how to transmit on the CO according to the preset/(pre-)configured criteria and/or according to the indications of the first UE, for example, when receiving the indications from the first UE, transmitting on the CO based on the indications, otherwise transmitting on the CO according to the preset criteria.

Optionally, when the first UE transmits a sidelink signal and/or channel on the initialized CO, it indicates that the CO is the CO initialized by the first UE; and/or, when the first UE transmits a sidelink signal and/or channel on the shared CO, it indicates that the CO is a shared CO. Optionally, the above two situations are indicated in the SCI. For example, a field including 1 bit in the SCI indicates that the CO where the current transmission is located is two statuses of a CO initialized by the transmitting UE of the SCI and a CO shared to the transmitting UE of the SCI.

Optionally, the first UE initializes the CO and shares the CO with the second UE, and indicates to share the CO through signaling, further including at least one of:
the first UE transmits a PSSCH to a second UE, and indicates to share CO with the second UE in the PSCCH associated with the PSSCH;
the first UE transmits a PSFCH to a second UE, and indicates to share CO with the second UE in the PSCCH; the PSCCH may or may not indicate an association with the PSFCH. The technical motivation of this method is that the first UE may receive the PSSCH from the second UE in the previous CO, but cannot transmit the HARQ-ACK feedback in time in the previous CO, so the current CO is initialized and at least used to transmit the HARQ-ACK feedback to the second UE. Since the second UE may retransmit or transmit new data according to the result of HARQ-ACK feedback, it is expected that the first UE will share the current CO with the second UE, which will contribute to the transmission efficiency. Therefore, although the PSFCH may or may not have an associated PSCCH, the first UE can still transmit a PSCCH to indicate the sharing of CO to the second UE and indicate the information of the shared CO. Therefore, an alternative method is that the UE can indicate to share the related information of CO in a PSCCH without associated PSSCH and/or PSFCH, and/or the UE can transmit a PSCCH without associated PSSCH and/or PSFCH to indicate the information in order to share the CO; the PSCCH without associated PSSCH and/or PSFCH can be called a stand-alone PSCCH. Further, if the UE initializes a CO for transmitting PSFCH and/or HARQ-ACK feedback information (which can be carried in other channels) and shares the CO with other UEs, a stand-alone PSCCH can be transmitted to indicate the information for sharing the CO.

Optionally, when the second UE transmits a signal and/or channel on the CO, it indicates whether the CO is initialized by the second UE or shared to the second UE; and/or it indicates whether other UEs (which may or may not include the first UE that initialized the CO) receiving the signal and/or channel can transmit HARQ-ACK on the CO. Optionally, whether other UEs receiving the signal and/or channel (which may or may not include the first UE that initializes the CO) can transmit HARQ-ACK on the CO is determined according to the preset/(pre-)configured criteria and/or the indication of the first UE. Alternatively, the first UE may transmit HARQ-ACK feedback on the CO without determining based on the indication of the second UE.

Optionally, and/or other UE determines whether it is necessary to transmit HARQ-ACK feedback according to preset/(pre-)configured criteria and/or based on the indication of the second UE. For example, the second UE transmits the groupcasted PSSCH to the first UE and the third UE, and indicates in the associated PSCCH that HARQ-ACK feedback is enabled and that the third UE cannot transmit HARQ-ACK on the CO; the first UE transmits the HARQ-ACK feedback to the second UE, and the third UE does not transmit the HARQ-ACK feedback to the second UE.

FIG. 7 illustrates another flowchart of a method according to various embodiments of the present disclosure.

In the sidelink communication system, in order to avoid the congestion of the resource pool caused by the UE occupying the channel in the same resource pool for a long time, and it is difficult for other UEs to acquire transmission resources in this resource pool, the UE needs to keep measuring the congestion degree of the resource pool and perform congestion control based on the measurement results. Specifically, when UE transmits PSSCH on slot n, it should determine the channel occupancy ratio (CR) corresponding to any priority, and ensure that the sum of CR corresponding to each priority does not exceed the CR upper limit; the CR upper limit is a parameter configured by the higher layer, which is related to the priority and the channel busy ratio (CBR) measured by UE in slot n-N, where n is the processing time of congestion control. CR is determined based on the ratio of resources occupied by UE's own transmission to the total resources in the resource pool, which can be considered as reflecting how many transmissions the UE can transmit; CBR is determined based on the ratio of frequency-domain resources of which received signal strength indicator (RSSI) exceeds a given threshold, which is measured by the UE within the configured measurement window, and can be considered as reflecting the congestion degree of the resource pool. If the sum of CR corresponding to the resources occupied by the UE's own transmission exceeds the CR upper limit determined based on the priority and CBR, the UE needs to drop part of the transmission to meet the upper limit. This method is mainly applied to sidelink communication, and it needs to be considered how to apply it to other sidelink signals and/or channels, such as sidelink positioning reference signal SL PRS.

Optionally, the UE measures CBR, including measuring CBR in at least one of the following resource pools: a resource pool that can be used for SL PRS and PSSCH transmission; a resource pool that can be used for SL PRS transmission but not for PSSCH transmission; a resource pool that can be used for PSSCH transmission but not for SL PRS transmission. This classification is mainly used to distinguish whether a resource pool can support sidelink positioning signals and sidelink data, and does not limit whether other signals and/or channels, such as PSCCH/PSFCH, can be transmitted in the resource pool. Optionally, the UE determines at least one of the following based on whether the resource pool supports transmission of PRS and/or whether it supports transmission of PSSCH: a method of measuring CBR in the resource pool, a method of determining CR in the resource pool, and a method of dropping transmission based on CR upper limit in the resource pool.

Optionally, the CBR measured in the slot n includes CBRO, which corresponds to the ratio of subchannels in the resource pool on which the RSRP and/or RSSI of the SL PRS measured by the UE exceed the (pre-)configured threshold within the CBR measurement window [n-a, n-b]. Optionally, the CBR measurement window is determined based on the SL PRS measurement window for positioning. For example, the CBR measurement window is predefined and/or (pre-)configured (the values of a and b are predefined and/or (pre-)configured), and/or its start and/or end positions are determined based on the start and/or end positions of the SL PRS measurement window for positioning, and/or based on the time domain resources on which the SL PRS measurement is performed; specifically, if the UE performs SL PRS measurement on some time domain resources within the pre-configured measurement window, it performs SL CBR measurement based on these time domain resources, and limits the calculation of SL CBR to the time domain resources used for SL CBR measurement (and/or SL PRS measurement). Optionally, if the UE measures CBR in a resource pool, and the resource pool can be used for SL PRS transmission and not for PSSCH transmission, the above method of measuring CBRO in slot n and/or the above CBR measurement window can be used.

Optionally, the CBR measured at slot n includes at least one of:
CBR1 corresponding to the ratio of subchannels on which RSSI exceeds the (pre-)configured threshold measured by UE in the resource pool in the CBR measurement window;
CBR2 corresponding to the ratio of subchannels (and/or slots) on which the RSRP and/or RSSI of the SL PRS measured by the UE exceed the (pre-)configured threshold in the first resource set in the CBR measurement window. Optionally, the first resource set includes at least one of the following: all time domain and/or frequency-domain resources in the resource pool, a predetermined and/or (pre-)configured resource set, and a resource set used for transmitting SL PRS in the resource pool. Alternatively, when a subchannel is used to transmit SL PRS, the UE can measure CBR2 on the subchannel;
CBR3 corresponding to the ratio of subchannels on which the RSRP (which can be based on the RSRP measurement) and/or RSSI of PSCCH and/or PSSCH measured by UE exceeds the (pre-)configured threshold in the second resource set in the CBR measurement window. Optionally, the second resource set includes at least one of all time-domain and/or frequency-domain resources in the resource pool, a predetermined and/ or (pre-)configured resource set, and a resource set used for transmitting PSCCH and/ or PSSCH in the resource pool. Alternatively, when a subchannel is used to transmit PSCCH and/or PSSCH, the UE can measure CBR3 on the subchannel;
CBR4 corresponding to at least one of CBR1, CBR2 and CBR3 multiplied by scaling factor a or added with offset k. The scaling factor and/or offset can be (pre-)configured and/or predetermined, and can be determined based on the ratio between at least two of resources used for transmitting SL PRS, resources used for transmitting PSCCH and/or PSSCH, and all time-frequency-domain resources in the resource pool. For example, CBR2 corresponds to the ratio of subchannels (and/or slots) on which the RSRP and/or RSSI of SL PRS measured by UE exceed the (pre-)configured threshold in all time-frequency-domain resources in the resource pool in the CBR measurement window, CBR4=CBR2/a or CBR4=CBR1/a, and a is a ratio of resources in the resource pool that are configured to transmit SL PRS in all time-frequency-domain resources in the resource pool.

Optionally, the CBR measurement window is determined based on the SL PRS measurement window for positioning, and/or at least when the measured CBR is based on the measurement of SL PRS, the CBR measurement window is determined based on the SL PRS measurement window for positioning. The specific method is similar to the measurement window corresponding to CBRO.

Optionally, if the UE measures CBR in a resource pool, and the resource pool can be used for SL PRS transmission and PSSCH transmission, the above-mentioned method for measuring CBR in slot n (for example, at least one of CBR1, CBR2, CBR3 and CBR4) and/or the above-mentioned CBR measurement window are used.

Optionally, if part of the frequency-domain resources in the resource pool is configured to transmit SL PRS, the first resource set corresponds to the frequency-domain resources. A specific example is that when the first subchannel set is configured for PSCCH and/or PSSCH transmission and the second subchannel set is configured for SL PRS transmission in the resource pool, the first resource set corresponds to the second subchannel set.

Optionally, if part of time-domain resources in the resource pool is configured to transmit SL PRS, the first resource set corresponds to the time-domain resources. A specific example is that when the first slot set in the resource pool is configured for PSCCH and/or PSSCH transmission and the second slot set is configured for SL PRS transmission, the first resource set corresponds to the second slot set. For example, the CBR measurement window is [n=100, n−1], in which 89 slots are configured for PSCCH and/or PSSCH transmission and 10 slots are configured for SL PRS transmission. When the frequency domain of the resource pool totals N subchannels, the first resource set corresponds to a total of 10*N subchannels in the 10 slots configured for SL PRS transmission, and CBR2=x/10*N, where x is the subchannel on which the RSRP and/or RSSI of SL PRS exceeds the (pre-)configured threshold.

Optionally, if part of the frequency-domain resources and/or time domain resources in the resource pool is configured for transmitting PSCCH and/or PSSCH, the second resource set corresponds to the frequency-domain resources and/or time domain resources. The specific method is similar to the first resource set.

Optionally, for any CBR measurement window mentioned above (for example, corresponding to any one of CBR 0, 1, 2, 3 and 4), if the CBR measurement is based on the measurement of SL PRS and/or if the CBR measurement is based on the measurement of PSCCH and/or PSSCH, at least one of the start position (or parameters related to the start position), the end position (or parameters related to the end position), the measurement window length of the CBR measurement window may be a predetermined and/or (pre-)configured CBR measurement window multiplied by scaling factor a or added with offset k. The scaling factor and/or offset can be (pre-)configured and/or predetermined, and can be determined based on the ratio between at least two of resources used for transmitting SL PRS, resources used for transmitting PSCCH and/or PSSCH, and all time-frequency-domain resources in the resource pool. For example, CBR2 corresponds to the ratio of subchannels (and/or slots) on which the RSRP and/or RSSI of SL PRS measured by UE exceed the (pre-)configured threshold in all time-frequency-domain resources in the resource pool in the CBR measurement window, and the (pre-)configured and/or predetermined measurement window is [n−a, n−1], then the measurement window corresponding to CBR2 is [n−a/α, n−1], where a is the ratio of the resources in the resource pool that can be used to transmit SL PRS in all time-frequency-domain resources in the resource pool.

Optionally, if the CBR measured at slot n includes more than one CBR, the CBR measured at slot n is determined by at least one of the following methods:
the CBR measured in slot n is the maximum value among the more than one CBR;
the CBR measured in slot n is the minimum value among the more than one CBR;
the CBR measured in slot n is the average of the more than one CBR. Further, the weighted average value is included, and the weighting factor can be predefined and/or (pre-)configured, and/or determined based on the ratio between at least two of the resources used for transmitting SL PRS, the resources used for transmitting PSCCH and/or PSSCH, and all time-frequency-domain resources in the resource pool. For example, CBR=CBR2*α+CBR3*ß, where α and β are weighting factors, a is the ratio of resources in the resource pool that can be used to transmit SL PRS in all time-frequency-domain resources in the resource pool, and β is the ratio of resources in the resource pool that can be used to transmit PSCCH and/or PSSCH in all time-frequency-domain resources in the resource pool.

Optionally, the method for UE to drop transmission based on CR upper limit in the resource pool includes at least one of:
by dropping the transmission of SL PRS and/or PSCCH and/or PSSCH, the CR corresponding to all transmissions (which can be understood as all SL PRS, PSCCH and PSSCH transmissions, and/or that all transmissions may not include PSFCH transmissions) does not exceed the CR upper limit;
if the first CR upper limit corresponds to CBR measured based on SL PRS, the first CR corresponding to SL PRS transmission will not exceed the first CR upper limit by dropping the transmission of SL PRS;
if the second CR upper limit corresponds to the CBR measured based on PSCCH and/or PSSCH, the second CR corresponding to SL PRS transmission will not exceed the second CR upper limit by dropping the transmission of PSCCH and/or PSSCH.

Optionally, the method for UE to drop transmission based on CR upper limit in the resource pool includes dropping transmission based on priority. Further, the UE acquires the priority of SL PRS and/or the priority of PSCCH and/or PSSCH; the UE uses at least one of the following methods to drop transmission based on the CR upper limit:
based on the priority of the transmission, the transmission with lower priority is preferentially dropped to meet the CR upper limit, wherein the transmission includes SL PRS, PSCCH and/or PSSCH transmission; this method can be considered that the priorities of SL PRS, PSCCH and PSSCH are equal, and it can also be understood that the transmission is dropped according to the priority parameter and not according to other parameters;
based on the priority of transmission, the transmission with lower priority is dropped to meet the CR upper limit; if the transmission is SL PRS transmission, the priority of the transmission is the priority of SL PRS plus a predetermined/(pre-)configured offset; and/or, if the transmission is PSCCH and/or PSSCH transmission, the priority of the transmission is the priority of PSCCH and/or PSSCH plus a predetermined/ (pre-)configured offset;
based on predetermined and/or (pre-)configured criteria, SL PRS transmission is determined to be dropped preferentially, and/or PSCCH and/or PSSCH transmission is determined to be dropped preferentially.

Optionally, for the method of preferentially dropping the transmission with lower priority based on the priority of the transmission to meet the CR upper limit, a feasible way is not to define a specific priority for SL PRS, but to define a priority threshold for dropping the transmission for it. Specifically, when the priority of PSCCH and/or PSSCH is lower than the threshold (the value of priority is higher than the threshold), PSCCH and/or PSSCH are dropped; otherwise, SL PRS is dropped.

In the unlicensed frequency band, LBT band is divided for performing LBT, which is also called RB set in the channel access procedure. The UE can perform LBT on a RB set and determine whether channel access can be performed according to the LBT result. According to the attribute of the service, the UE can also access channels on multiple RB sets, and transmit data on these RB sets if the access is successful. This process is also called multi-channel access procedure.

When the sidelink communication system uses the multi-channel access procedure, the transmitting UE can transmit PSSCH on multiple RB sets and transmit PSCCH on multiple RB sets or a subset thereof (for example, the one with the lowest index).

For data with multi-channel access, how to transmit the corresponding feedback channel also needs to be determined. The main advantage of multi-channel access is that the single transmission of UE can use more bandwidth, thus improving the data rate; however, the amount of information carried by the feedback channel is usually small, so the feedback channel corresponding to the data of multi-channel access can use multi-channel access or be transmitted on a subset of the multiple channels.

Optionally, if the transmitting UE transmits the PSSCH on multiple RB sets based on the multi-channel access procedure, the transmitting UE may receive the PSFCH corresponding to the PSSCH based on at least one of the following methods, and/or the receiving UE may transmit the PSFCH corresponding to the PSSCH based on at least one of the following methods:
transmitting/receiving the PSFCH on a specific RB set (e.g., one with the lowest index or the lowest frequency domain position) among multiple RB sets. Optionally, the corresponding PSFCH resources are determined in the one RB set based on the preset mapping rules between PSSCH and PSFCH and the resources used by PSSCH, and the mapping rules can be independent of the used RB set;
transmitting/receiving PSFCH on one or more RB sets among multiple RB sets; the one or more RB sets are selected based on the channel interference condition, and further, based on at least one of the following: the UE successfully accesses the channel based on LBT on the RB set (optionally, successfully accessing the channel earlier than other RB sets), that is, the LBT on the RB set is successful; the interference on this RB set is lower, for example, at least one of CBR measurement result, RSSI measurement result and RSRP measurement result on this RB set is lower than other RB sets. A specific example is that for the PSSCH transmitted on multiple RB sets, the UE performs LBT on each RB set of the multiple RB sets respectively, and transmits the PSFCH on the RB set with successful LBT. Optionally, the UE determines the corresponding PSFCH resources in each RB set based on the preset mapping rules between PSSCH and PSFCH and the resources used by PSSCH, which may be independent of the used RB set. Optionally, the method is used for the receiving UE to transmit the PSFCH, and the transmitting UE to receive the PSFCH on all multiple RB sets;
according to a preset and/or (pre-)configured mapping rule, the UE selects at least one RB set from multiple RB sets for transmitting/receiving the PSFCH. Optionally, the mapping rule includes: in the multiple RB sets, indexing the PSSCH resources according to a time domain ascending order and/or a frequency domain ascending order, where the indexing method of the time domain ascending order includes index ascending order according to slots or other time units within a PSFCH period (the period in which the PSFCH resources occur), the indexing method of the frequency domain ascending order includes at least one of index ascending order according to RB set, index ascending order according to subchannel, index ascending order according to interleaving and index ascending order according to RB, and may further include a sequence, for example, index ascending order according to RB set first and then index ascending order according to subchannel; and indexing the PSFCH resources according to the time domain ascending order and/or the frequency domain ascending order, where the indexing method of the frequency domain ascending order includes at least one of index ascending order according to RB set, index ascending order according to interleaving and index ascending order according to RB; and determining a mapping relationship between the PSSCH resources and the PSFCH resources according to the mapping relationship between the indexes of the PSSCH resources and the indexes of the PSFCH resources (for example, by a remainder operation).

FIG. 8 illustrates a block diagram of a configuration of a user equipment (UE) 800 according to various embodiments of the present disclosure.

Referring to FIG. 8, a UE 800 according to various embodiments of the present disclosure may include a transceiver 801 and a controller 802. For example, the transceiver 801 may be configured to transmit and receive signals. For example, the controller 802 may be coupled to the transceiver 801 and configured to perform the aforementioned methods.

Although the UE is illustrated as having separate functional blocks for convenience of explanation, the configuration of the UE is not limited thereto. For example, the UE may include a communication unit including a transceiver and a controller. The UE may communicate with at least one network node by means of the communication unit.

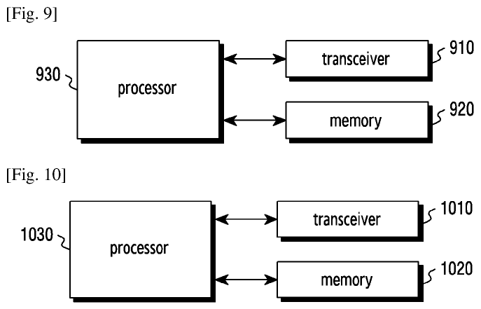

FIG. 9 illustrates a block diagram illustrating a structure of a user equipment (UE) according to an embodiment of the disclosure. FIG. 9 corresponds to the example of the electronic device of FIG. 3A and FIG. 8.

As shown in FIG. 9, the UE according to an embodiment may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. Also, the processor 930 may include at least one processor.

The transceiver 910 collectively refers to a UE receiver and a UE transmitter, and may transmit/receive a signal to/from a base station or a network entity. The signal transmitted or received to or from the base station or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the UE.

Also, the memory 920 may store control information or data included in a signal obtained by the UE. The memory 920 may be a storage medium, such as read-only memory (ROM), random access memory (RAM), a hard disk, a CD-ROM, and a DVD, or a combination of storage media.

The processor 930 may control a series of processes such that the UE operates as described above. The processor 930 may refers to a controller. For example, the transceiver 910 may receive a data signal including a control signal transmitted by the base station or the network entity, and the processor 930 may determine a result of receiving the control signal and the data signal transmitted by the base station or the network entity.

FIG. 10 illustrates a block diagram illustrating a structure of a base station (BS) according to an embodiment of the disclosure. FIG. 10 corresponds to the example of the electronic device of FIG. 3B.

As shown in FIG. 10, the base station according to an embodiment may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. In addition, the processor 1030, the transceiver 1010, and the memory 1020 may be implemented as a single chip. Also, the processor 1030 may include at least one processor.

The transceiver 1010 collectively refers to a base station receiver and a base station transmitter, and may transmit/receive a signal to/from a terminal or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the base station. Also, the memory 1020 may store control information or data included in a signal obtained by the base station. The memory 1020 may be a storage medium, such as read-only memory (ROM), random access memory (RAM), a hard disk, a CD-ROM, and a DVD, or a combination of storage media.

The processor 1030 may control a series of processes such that the base station operates as described above. The processor 1030 may refers to a controller. For example, the transceiver 1010 may receive a data signal including a control signal transmitted by the terminal, and the processor 1030 may determine a result of receiving the control signal and the data signal transmitted by the terminal.

According to embodiments of the present disclosure, at least a part of the UE (e.g., modules or their functions) or the methods (e.g., operations or steps) may be implemented as instructions stored in a computer-readable storage medium (e.g., memory) in the form of program modules, for example. When executed by a processor or controller, the signalings may enable the processor or controller to perform corresponding functions. The computer-readable media may include, for example, hard disk, floppy disk, magnetic media, optical recording media, DVD, magneto-optical media. The signalings may include code created by a compiler or code executable by an interpreter. The module or UE according to various embodiments of the present disclosure may include at least one or more of the above components, some of which may be omitted, or other additional components. Operations performed by modules, programming modules or other components according to various embodiments of the present disclosure may be performed sequentially, in parallel, repeatedly or heuristically, or at least some operations may be performed in a different order or omitted, or other operations may be added.

What has been described above is only exemplary embodiments of the present disclosure, and is not intended to limit the scope of protection of the present disclosure, which is determined by the appended claims.

1-15. (canceled)

16. A user equipment (UE) in a wireless communication system, the UE comprising:
a transceiver; and
a memory storing one or more programs; and
one or more processors communicatively coupled to the transceiver and the memory,
wherein the one or more programs include computer-executable instructions that, when executed by the one or more processors individually or collectively, cause the UE to:
perform a contention window adjustment procedure for a priority class associated with a physical sidelink shared channel (PSSCH),
perform a channel access procedure based on the contention window adjustment procedure, and
transmit a sidelink signal including the PSSCH,
wherein the contention window adjustment procedure includes at least one of setting a value of a contention window as a minimum value of the contention window or increasing the value of the contention window to a next higher value.

17. The UE of claim 16, wherein the value of the contention window is determined according to hybrid automatic repeat and request (HARQ)-acknowledgement (ACK) feedback.

18. The UE of claim 16, wherein the computer-executable instructions, when executed by the one or more processors individually or collectively, further cause the UE to:
identify that hybrid automatic repeat and request (HARQ)-acknowledgement (ACK) feedback for a groupcast sidelink transmission is in a reference duration, and
identify a ratio between a number of ACKs in the HARQ-ACK feedback and a number of UEs for the HARQ-ACK feedback,
wherein, in case that the ratio is greater than or equal to a threshold value, the value of the contention window is set as the minimum value of the contention window, and
wherein, in case that the ratio is less than the threshold value, the value of the contention window is increased to the next higher level.

19. The UE of claim 18, wherein the reference duration corresponding to a channel occupancy initiated by the UE is a duration starting from a beginning of the channel occupancy until an end of a first slot where the PSSCH with the HARQ-ACK feedback is transmitted.

20. The UE of claim 16, wherein, for the PSSCH without associated HARQ-ACK feedback, the value of the contention window is increased to the next higher level.

21. The UE of claim 16, wherein, in case that the value of the contention window is a maximum value of the contention window and consecutively used K times, the value of the contention window is set as the minimum value of the contention window.

22. The UE of claim 16, wherein the channel access procedure is for a shared spectrum channel.

23. A method performed by a user equipment (UE), the method comprising:
performing a contention window adjustment procedure for a priority class associated with a physical sidelink shared channel (PSSCH);
performing a channel access procedure based on the contention window adjustment procedure; and
transmitting a sidelink signal including the PSSCH,
wherein the contention window adjustment procedure includes at least one of setting a value of a contention window as a minimum value of the contention window or increasing the value of the contention window to a next higher value.

24. The method of claim 23, wherein the value of the contention window is determined according to hybrid automatic repeat and request (HARQ)-acknowledgement (ACK) feedback.

25. The method of claim 23, further comprising:
identifying that hybrid automatic repeat and request (HARQ)-acknowledgement (ACK) feedback for a groupcast sidelink transmission is in a reference duration; and
identifying a ratio between a number of ACKs in the HARQ-ACK feedback and a number of UEs for the HARQ-ACK feedback,
wherein, in case that the ratio is greater than or equal to a threshold value, the value of the contention window is set as the minimum value of the contention window, and
wherein, in case that the ratio is less than the threshold value, the value of the contention window is increased to the next higher level.

26. The method of claim 25, wherein the reference duration corresponding to a channel occupancy initiated by the UE is a duration starting from a beginning of the channel occupancy until an end of a first slot where the PSSCH with the HARQ-ACK feedback is transmitted.

27. The method of claim 23, wherein, for the PSSCH without associated HARQ-ACK feedback, the value of the contention window is increased to the next higher level.

28. The method of claim 23, wherein, in case that the value of the contention window is a maximum value of the contention window and consecutively used K times, the value of the contention window is set as the minimum value of the contention window.

29. The method of claim 23, wherein the channel access procedure is for a shared spectrum channel.
